(19) United States
(12) Patent Application Publication
(10) Pub. No.: US 2026/0185670 A1
(43) Pub. Date: Jul. 2, 2026

(54) EMERGENCY PEDESTAL WITH LIGHTING PROJECTION DEVICE

(71) Applicant: EATON INTELLIGENT POWER LIMITED, DUBLIN 4 (IE)

(72) Inventors: Mark W. Mosser, Williamsburg, VA (US); Jack M. Notley, Williamsburg, VA (US); Paul D. Seff, Williamsburg, VA (US); Greg Storck, Williamsburg, VA (US)

(73) Assignee: EATON INTELLIGENT POWER LIMITED, DUBLIN 4 (IE)

(21) Appl. No.: 19/424,524

(22) Filed: Dec. 18, 2025

Related U.S. Application Data
(60) Provisional application No. 63/740,362, filed on Dec. 31, 2024.

(51) Int. Cl. F21S 8/02; F21V 9/08; F21V 11/08; F21V 33/00; F21W 131/402

(52) U.S. Cl. CPC F21S 8/026; F21V 9/08; F21V 11/08; F21V 33/006; F21W 2131/402

(57) ABSTRACT

An improved emergency pedestal includes a lighting projection device to increase visibility and identifiability of the emergency pedestal. The lighting projection device is separate from an illumination lens that provides lighting to illuminate the area around the emergency pedestal. The lighting projection device is configured to project an illuminated image on a nearby ground surface. The illuminated image depicts a fire extinguisher and/or text or other imagery that identifies the emergency pedestal as specifically being an emergency pedestal. Projecting the illuminated image helps a user to clearly differentiate the emergency pedestal from other outdoor pedestals such as power pedestals, especially in low ambient lighting or low visibility conditions.

### CROSS REFERENCE TO RELATED APPLICATIONS

This application claims priority to U.S. Provisional Patent Application Ser. No. 63/740,362 filed on Dec. 31, 2024 and titled “FIRE EXTINGUISHER PEDESTAL WITH LIGHTING PROJECTION DEVICE”, the disclosure of which is incorporated herein by reference.

### FIELD OF THE INVENTION

The disclosed concept relates generally to emergency pedestals, and in particular, to devices used to identify emergency pedestals.

### BACKGROUND OF THE INVENTION

Emergency pedestals are outdoor structures that provide emergency resources for areas such as RV parks, campgrounds, and marinas. Such resources can include, for example and without limitation, fire extinguisher storage and area lighting that provides easy identification of the pedestal during an emergency. In addition, an emergency pedestal can include additional optional features that provide heightened utility in particular contexts, such as a life ring flotation device installed on an emergency pedestal used at pool facilities or waterfront areas, or an alarm strobe light and/or siren that are automatically activated when the fire extinguisher cabinet door is opened or the optional life ring is removed. Emergency pedestals typically comprise an upstanding housing with a base. The housing is made from a weather-resistant material and is designed to enclose and protect various components such as electrical components that would be compromised by exposure to the elements. In particular, the housing and pedestal are structured to protect electrical components from the environment and to prevent electrical faults caused by moisture.

Power pedestals are another type of outdoor pedestal that are used in similar settings in which emergency pedestals are used, with power pedestals being structured and designed to provide access to electrical power rather than fire and emergency resources. In settings where outdoor pedestals are used, it is common to find both emergency pedestals and power pedestals installed. While emergency pedestals and power pedestals have distinct functionality, the two types of pedestals tend to be of a similar size and have a somewhat similar appearance, especially in low light conditions. In marina settings in particular, lighting is fairly dim at night, such that emergency pedestals and power pedestals can be easily confused for one another. In an emergency situation under low lighting conditions where an emergency pedestal is being sought, being able to easily distinguish an emergency pedestal from a power pedestal can prevent wasting of critical time.

There is thus room for improvement in emergency pedestals and in devices used to identify emergency pedestals.

### SUMMARY OF THE INVENTION

These needs, and others, are met by an improved emergency pedestal that includes a lighting projection device to provide increased visibility and identifiability of the emergency pedestal. The lighting projection device is separate from an illumination lens that provides lighting to illuminate the area around the emergency pedestal. The lighting projection device is configured to project an illuminated image on a nearby ground surface. The illuminated image depicts a fire extinguisher and/or text or other imagery that identifies the emergency pedestal as specifically being an emergency pedestal. Projecting the illuminated image helps a user to clearly differentiate the emergency pedestal from other outdoor pedestals such as power pedestals, especially in low ambient lighting or low visibility conditions.

In accordance with one aspect of the disclosed concept, an emergency pedestal comprises: a housing structured to enclose a fire extinguisher; a roof coupled to the housing; and a lighting projection device mounted on the housing or the roof. The lighting projection device is mounted on the housing or the roof such that, when the housing is seated on a ground surface, the lighting projection device is disposed above the ground surface. The lighting projection device is positioned such that, when the lighting projection device is activated, the lighting projection device projects an illuminated image on the ground surface a distance away from where the housing is seated.

### BRIEF DESCRIPTION OF THE DRAWINGS

A full understanding of the invention can be gained from the following description when read in conjunction with the accompanying drawings in which:

FIG. 1 is a perspective view of an improved emergency pedestal with a lighting projection device, in accordance with an example embodiment of the disclosed concept; and

FIG. 2 is an overhead view of the improved emergency pedestal shown in FIG. 1 and the projected illuminated image produced by the lighting projection device of FIG. 1.

### DETAILED DESCRIPTION OF THE INVENTION

Directional phrases used herein, such as, for example, left, right, front, back, top, bottom and derivatives thereof, relate to the orientation of the elements shown in the drawings and are not limiting upon the claims unless expressly recited therein.

As employed herein, the statement that two or more parts or components are “coupled” shall mean that the parts are joined or operate together either directly or indirectly, i.e., through one or more intermediate parts or components, so long as a link occurs. As used herein, “directly coupled” means that two elements are directly in contact with each other. As used herein, “fixedly coupled” or “fixed” means that two components are coupled so as to move as one while maintaining a constant orientation relative to each other.

As employed herein, when ordinal terms such as “first” and “second” are used to modify a noun, such use is simply intended to distinguish one item from another, and is not intended to require a sequential order unless specifically state.

As employed herein, the term “number” shall mean one or an integer greater than one (i.e., a plurality).

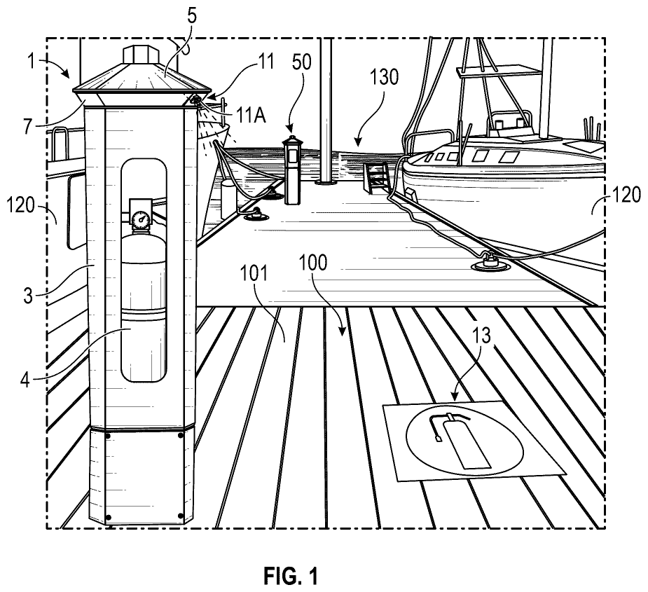

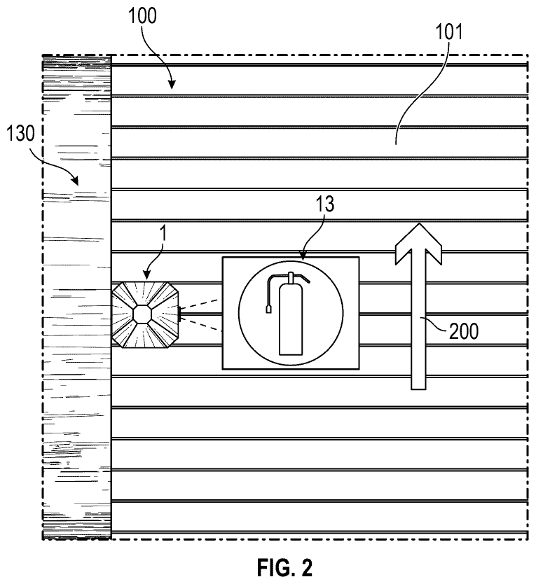

Reference is now made to FIG. 1, which shows an improved emergency pedestal 1 that includes a lighting projection device to increase visibility and identifiability of the emergency pedestal, in accordance with an exemplary embodiment of the disclosed concept. The disclosed improved emergency pedestal 1 provides increased visibility and identifiability relative to known emergency pedestals. FIG. 2 is an overhead view of the emergency pedestal 1. While the emergency pedestal 1 is suitable for use in a variety of settings, FIGS. 1 and 2 depict the emergency pedestal 1 installed on a dock 100 in a marina.The ground surface of the dock 100 is numbered with the reference number 101. To provide environmental context, two boats 120 tied up to the dock 100 and the water 130 into which the dock 100 extends are shown in FIG. 1. The arrow numbered with the reference number 200 shown in FIG. 2 represents a person 200 walking on the dock 100 near the emergency pedestal 1.

The emergency pedestal 1 comprises a housing 3 structured to enclose a fire extinguisher 4 and a roof 5 that is coupled to the top of the housing 3. In FIG. 1, the emergency pedestal 1 is shown including a 360-degree illumination lens 7 as part of the roof 5. In an exemplary embodiment of the disclosed concept, the illumination lens 7 shines red light, in order to signify that the pedestal 1 is specifically an emergency pedestal. However, in an emergency situation occurring under low visibility conditions (e.g. at nighttime), seeing red light projected by the illumination lens 7 may not sufficiently alert people in the vicinity that the pedestal 1 is specifically an emergency pedestal, or the knowledge may be momentarily forgotten by people feeling a sense of stress or panic.

To address the need for an indicator that clearly identifies the emergency pedestal 1 as specifically being an emergency pedestal (as opposed to another type of outdoor pedestal such as a power pedestal 50, shown in the background in FIG. 1), the emergency pedestal 1 includes a lighting projection device 11 that is not found in known emergency pedestals. The lighting projection device 11 is configured to be selectively activated by a user and is disposed above the ground surface 101 on which the housing 3 rests. In one non-limiting embodiment of the emergency pedestal 1 as shown in FIG. 1, the lighting projection device 11 is integrated into the roof 5 such that the lighting projection device 11 is situated primarily within the interior of the roof 5 with only a projection lens 11A of the lighting projection device 11 being situated on the exterior of the roof 5. In FIG. 1, the portion of the lighting projection device 11 situated within the interior of the roof 5 is drawn in broken line, while the projection lens 11A is drawn in solid line.

In the embodiment of the emergency pedestal 1 shown in FIG. 1, the illumination lens 7 comprises an opening structured to receive the projection lens 11A, thus enabling the projection lens 11A to be situated on the exterior of the roof 5. However, the exact position of the lighting position device 11 can be adjusted (e.g. in order for the projection lens 11A to be situated elsewhere on the roof 5 or to be situated on the housing 3 instead of the roof 5) without departing from the scope of the disclosed concept, so long as the lighting projection device 11 is disposed above the ground surface 101 on which the housing 3 rests. It will be appreciated that in an embodiment where the projection lens 11A is situated on the housing 3 instead of the roof 5, the housing 3 can comprise an opening structured to receive the projection lens 11A in order to enable the projection lens 11A to be situated on the exterior of the housing 3.

When activated, the lighting projection device 11 projects an illuminated image 13 on the ground surface 101 in the vicinity of the housing 3 but disposed some distance away from the housing 3. By projecting the illuminated image 13 some distance away from the housing 3, the intent is to catch the attention of a person 200 walking near the emergency pedestal 1 but not necessarily right next to the emergency pedestal 1. As previously noted, the lighting projection device 11 can be provided in a location other than the exact location shown in FIG. 1 without departing from the scope of the disclosed concept, as the lighting projection device 11 simply needs to be disposed a sufficient distance above the ground surface 100 in order to produce a discernible image on the ground surface 101.

In an exemplary embodiment of the disclosed concept, the lighting projection device 11 uses go-between (GOBO) lighting, meaning that a stencil-type object is positioned within the interior of the housing 3 or roof 5 between the light source (not visible in the figures) of the lighting projection device 11 and the projection lens 11A in order to produce an image when the light source is activated. In one non-limiting exemplary embodiment of the disclosed concept as shown in FIG. 1, the illuminated image 13 depicts a fire extinguisher. It is expected that this illuminated image 13 will cause people nearby to identify the emergency pedestal 1 as specifically being an emergency pedestal more quickly than they otherwise would in the absence of the illuminated image 13, particularly at nighttime or under other low visibility conditions. It is noted that the illuminated image 13 can be configured to project images or text other than the fire extinguisher shown in FIG. 1 without departing from the scope of the disclosed concept. For example and without limitation, the illuminated image 13 could instead project the words “Fire Extinguisher” or “Emergency Pedestal” and optionally include an image of an arrow pointing toward the emergency pedestal 1.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

What is claimed is:

1. An emergency pedestal, the emergency pedestal comprising:
a housing structured to enclose a fire extinguisher;
a roof coupled to the housing; and
a lighting projection device mounted on the housing or the roof such that, when the housing is seated on a ground surface, the lighting projection device is disposed above the ground surface,
wherein the lighting projection device is positioned such that, when the lighting projection device is activated, the lighting projection device projects an illuminated image on the ground surface a distance away from where the housing is seated.

2. The emergency pedestal of claim 1,
wherein the lighting projection device employs go-between lighting.

3. The emergency pedestal of claim 1,
wherein the lighting projection device is structured such that the illuminated image includes a fire extinguisher image.

4. The emergency pedestal of claim 1,
wherein the roof comprises an illumination lens that shines light in a pattern that spans 360 degrees.

5. The emergency pedestal of claim 4,
wherein the illumination lens is configured to shine red light.

6. The emergency pedestal of claim 4,
wherein the lighting projection device is integrated into the roof such that the lighting projection device is situated primarily within the interior of the roof with only a projection lens of the lighting projection device being situated on the exterior of the roof.

7. The emergency pedestal of claim 6,
wherein the illumination lens comprises an opening structured to receive the projection lens.

8. The emergency pedestal of claim 1,
wherein the lighting projection device is integrated into the roof such that the lighting projection device is situated primarily within the interior of the roof with only a projection lens of the lighting projection device being situated on the exterior of the roof.

9. The emergency pedestal of claim 1,
wherein the lighting projection device is integrated into the housing such that the lighting projection device is situated primarily within the interior of the housing with only a projection lens of the lighting projection device being situated on the exterior of the housing.

10. The emergency pedestal of claim 1,
wherein the lighting projection device is structured such that the illuminated image includes the words “fire extinguisher”.

11. The emergency pedestal of claim 1,
wherein the lighting projection device is structured such that the illuminated image includes the words “emergency pedestal”.
